(19) United States
(12) Patent Application Publication
(10) Pub. No.: US 2023/0106213 A1
(43) Pub. Date: Apr. 6, 2023

(54) MACHINE LEARNING MODEL COMPRESSION USING WEIGHTED LOW-RANK FACTORIZATION

(71) Applicant: Samsung Electronics Co., Ltd., Suwon-si (KR)

(72) Inventors: Yen-Chang Hsu, Fremont, CA (US); Ting Hua, Cupertino, CA (US); Feixuan Wang, San Jose, CA (US); Qian Lou, Oviedo, FL (US); Yilin Shen, Santa Clara, CA (US); Hongxia Jin, San Jose, CA (US)

(21) Appl. No.: 17/932,225

(22) Filed: Sep. 14, 2022

Related U.S. Application Data
(60) Provisional application No. 63/252,239, filed on Oct. 5, 2021.
(60) Provisional application No. 63/355,552, filed on Jun. 24, 2022.

(51) Int. Cl. G06N 20/20; G06K 9/62

(52) U.S. Cl. CPC G06N 20/20; G06K 9/6262

(57) ABSTRACT

A method includes obtaining a parameter matrix associated with a linear layer of a first machine learning model and containing parameter values for parameters of the linear layer. The method also includes determining importance values corresponding to the parameter values. The method further includes generating factorized matrices such that a product of the importance values and factorized matrices contains approximated parameter values for the parameters of the linear layer. In addition, the method includes generating a second machine learning model representing a compressed version of the first machine learning model. The second machine learning model has first and second linear layers containing parameter values based on the importance values and the factorized matrices. The factorized matrices are generated based on weighted errors between the parameter values for the parameters of the linear layer and the approximated parameter values. Weights associated with the weighted errors are based on the importance values.

### CROSS-REFERENCE TO RELATED APPLICATIONS AND PRIORITY CLAIM

This application claims priority under 35 U.S.C. § 119(e) to U.S. Provisional Patent Application No. 63/252,239 filed on Oct. 5, 2021 and U.S. Provisional Patent Application No. 63/355,552 filed on Jun. 24, 2022. Both of these provisional applications are hereby incorporated by reference in their entirety.

### TECHNICAL FIELD

This disclosure relates generally to machine learning systems. More specifically, this disclosure relates to machine learning model compression using weighted low-rank factorization.

### BACKGROUND

Machine learning models, such as deep neural networks, are being used to perform more and more functions in electronic devices. In some cases, machine learning models can have numerous parameters, such as deep neural network models or other models that have millions of parameters. This introduces heavy computational complexities, memory usages, and power consumptions during use of the machine learning models. As a result, these machine learning models often cannot be deployed to and used by smartphones, tablet computers, smartwatches, augmented reality/virtual reality (AR/VR) headsets, or other resource-constrained devices.

### SUMMARY

This disclosure relates to machine learning model compression using weighted low-rank factorization.

In a first embodiment, a method includes obtaining, using at least one processing device of an electronic device, a parameter matrix associated with a linear layer of a first machine learning model and containing parameter values for parameters of the linear layer of the first machine learning model. The method also includes determining, using the at least one processing device, importance values corresponding to the parameter values. The method further includes generating, using the at least one processing device, factorized matrices such that a product of the importance values and the factorized matrices contains approximated parameter values for the parameters of the linear layer of the first machine learning model. In addition, the method includes generating, using the at least one processing device, a second machine learning model representing a compressed version of the first machine learning model. The second machine learning model has first and second linear layers containing parameter values based on the importance values and the factorized matrices. The factorized matrices are generated based on weighted errors between the parameter values for the parameters of the linear layer of the first machine learning model and the approximated parameter values. Weights associated with the weighted errors are based on the importance values.

In a second embodiment, an apparatus includes at least one processing device configured to obtain a parameter matrix associated with a linear layer of a first machine learning model and containing parameter values for parameters of the linear layer of the first machine learning model. The at least one processing device is also configured to determine importance values corresponding to the parameter values. The at least one processing device is further configured to generate factorized matrices such that a product of the importance values and the factorized matrices contains approximated parameter values for the parameters of the linear layer of the first machine learning model. In addition, the at least one processing device is configured to generate a second machine learning model representing a compressed version of the first machine learning model. The second machine learning model has first and second linear layers containing parameter values based on the importance values and the factorized matrices. The at least one processing device is configured to generate the factorized matrices based on weighted errors between the parameter values for the parameters of the linear layer of the first machine learning model and the approximated parameter values. Weights associated with the weighted errors are based on the importance values.

In a third embodiment, a non-transitory computer readable medium contains instructions that when executed cause at least one processor to obtain a parameter matrix associated with a linear layer of a first machine learning model and containing parameter values for parameters of the linear layer of the first machine learning model. The medium also contains instructions that when executed cause the at least one processor to determine importance values corresponding to the parameter values. The medium further contains instructions that when executed cause the at least one processor to generate factorized matrices such that a product of the importance values and the factorized matrices contains approximated parameter values for the parameters of the linear layer of the first machine learning model. In addition, the medium contains instructions that when executed cause the at least one processor to generate a second machine learning model representing a compressed version of the first machine learning model. The second machine learning model has first and second linear layers containing parameter values based on the importance values and the factorized matrices. The instructions that when executed cause the at least one processor to generate the factorized matrices include instructions that when executed cause the at least one processor to generate the factorized matrices based on weighted errors between the parameter values for the parameters of the linear layer of the first machine learning model and the approximated parameter values. Weights associated with the weighted errors are based on the importance values.

In a fourth embodiment, a method includes obtaining, using at least one processing device of an electronic device, input data. The method also includes providing, using the at least one processing device, the input data to a compressed machine learning model in order to generate a prediction. The method further includes performing, using the at least one processing device, an action based on the prediction. The compressed machine learning model includes first and second linear layers. Parameter values of the first and second linear layers are based on factorized matrices corresponding to a parameter matrix containing parameter values of a linear layer of a larger machine learning model. The factorized matrices are based on importance values corresponding to the parameter values of the linear layer of the larger machine learning model.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts;

FIG. 1 illustrates an example network configuration including an electronic device in accordance with this disclosure;

FIGS. 2A and 2B illustrate example low-rank factorizations for compressing machine learning models in accordance with this disclosure;

FIG. 3 illustrates an example usage of weighted low-rank factorization for compressing a machine learning model in accordance with this disclosure;

FIG. 4 illustrates an example generation of a compressed machine learning model using weighted low-rank factorization in accordance with this disclosure;

FIG. 5 illustrates an example generation and deployment of a compressed machine learning model in accordance with this disclosure;

FIG. 6 illustrates an example usage of a compressed machine learning model in accordance with this disclosure;

FIG. 7 illustrates an example use case for multiple compressed machine learning models in accordance with this disclosure;

FIG. 8 illustrates an example method for generating and deploying a compressed machine learning model in accordance with this disclosure; and

FIG. 9 illustrates an example method for using a compressed machine learning model in accordance with this disclosure.

### DETAILED DESCRIPTION

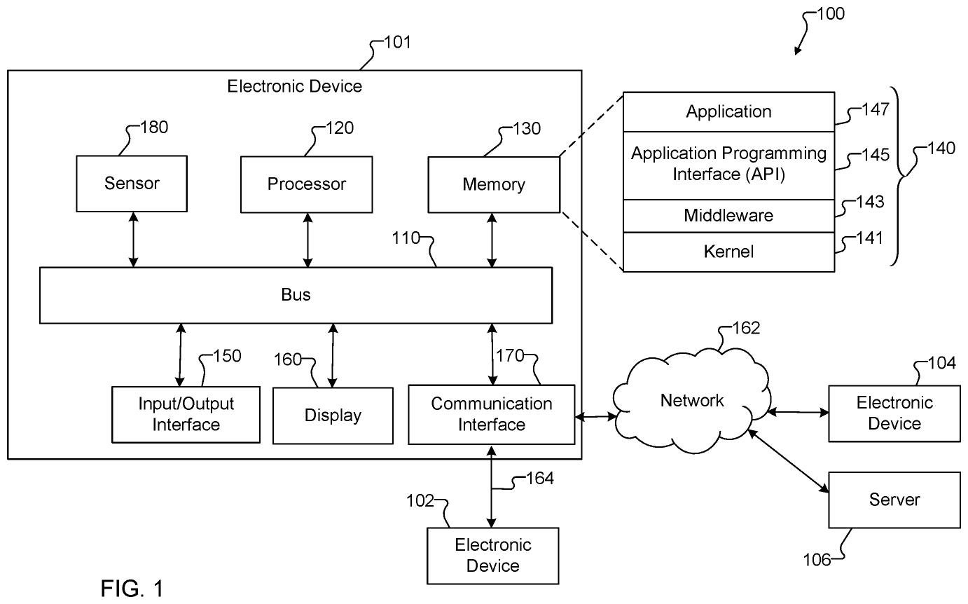

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, machine learning models, such as deep neural networks, are being used to perform more and more functions in electronic devices. In some cases, machine learning models can have numerous parameters, such as deep neural network models or other models that have millions of parameters. This introduces heavy computational complexities, memory usages, and power consumptions during use of the machine learning models. As a result, these machine learning models often cannot be deployed to and used by smartphones, tablet computers, smartwatches, augmented reality/virtual reality (AR/VR) headsets, or other resource-constrained devices.

In some prior approaches, attempts have been made to develop a smaller machine learning model, such as from scratch or by extracting a subset of a larger machine learning model's layers. The smaller model is then pretrained with a large corpus of training data, and knowledge from the larger machine learning model is distilled. This process is called generic pretraining and is often needed for a compact model to achieve good performance on one or more target tasks. However, generic pretraining can still require considerable amounts of computational resources, and these approaches may not be feasible for everyone who wants to create compact machine learning models.

This disclosure provides various techniques for machine learning model compression using weighted low-rank factorization. As described in more detail below, a parameter matrix associated with a first machine learning model contains parameter values for parameters of the first machine learning model. Importance values corresponding to the parameter values can be determined, where the importance values identify the importances of the parameters of the first machine learning model. The importance values are used to generate factorized matrices, where the factorized matrices are produced such that a product of the importance values and the factorized matrices contains approximated parameter values for the parameters of the first machine learning model. A second machine learning model (representing a compressed version of the first machine learning model) is generated and includes first and second layers that contain parameter values based on the importance values and the factorized matrices. Here, the factorized matrices are generated based on weighted errors between the parameter values for the parameters of the first machine learning model and the approximated parameter values, where weights associated with the weighted errors are based on the importance values. The second machine learning model may be deployed or otherwise used, such as to process input data and generate predictions that are used to select suitable actions.

In this way, various machine learning models that have been trained can be directly compressed in order to produce compressed machine learning models. Among other things, this compression can be achieved by applying a low-rank factorization to replace large linear layers with multiple smaller linear layers. It is also possible to fine-tune the compressed machine learning models after compression, such as by repeating at least a portion of a machine learning model training process. These techniques help to provide smaller machine learning models that can be suitable for use in resource-constrained devices or other devices. Moreover, the compressed machine learning models may be generated without the associated costs of performing generic pretraining and without losing significant accuracy. As a result, it is possible to achieve suitable model accuracy using smaller model sizes. In addition, the compressed machine learning models may be generated using less training, which can result in significant time, resource, and cost savings.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor 120 can be a graphics processor unit (GPU). As described below, the processor 120 may be used to generate a compressed machine learning model using weighted low-rank factorization. Also or alternatively, the processor 120 may be used to apply a compressed machine learning model (that was generated using weighted low-rank factorization) during inferencing.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 includes one or more applications related to generating or using compressed machine learning models. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as images.

The electronic device 101 further includes one or more sensors 180 that can meter a physical quantity or detect an activation state of the electronic device 101 and convert metered or detected information into an electrical signal. For example, one or more sensors 180 include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 includes at least one communication network, such as a computer network (like a local area network (LAN) or wide area network (WAN)), Internet, or a telephone network.

The first and second external electronic devices 102 and 104 and server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may be used to generate a compressed machine learning model using weighted low-rank factorization. Also or alternatively, the server 106 may be used to apply a compressed machine learning model (that was generated using weighted low-rank factorization) during inferencing.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

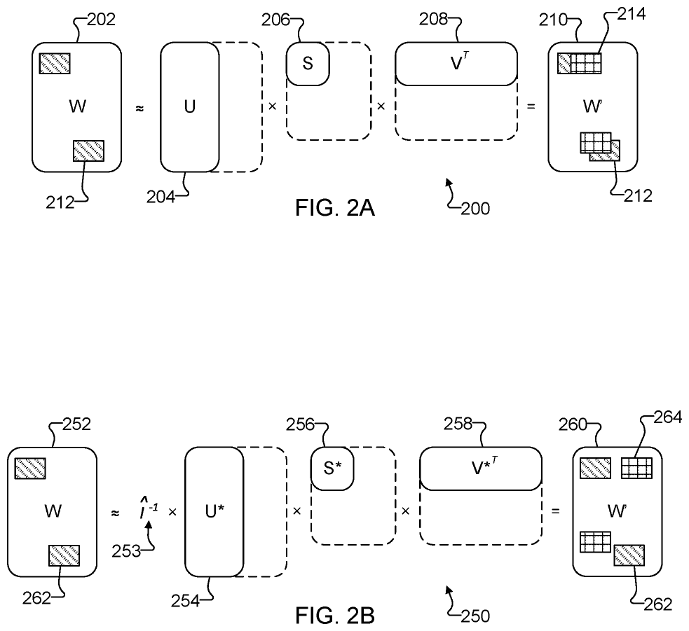

FIGS. 2A and 2B illustrate example low-rank factorizations 200, 250 for compressing machine learning models in accordance with this disclosure. In particular, FIG. 2A illustrates an example unweighted low-rank factorization 200, and FIG. 2B illustrates an example weighted low-rank factorization 250. As shown in FIG. 2A, the unweighted low-rank factorization 200 is used in conjunction with a parameter matrix (W) 202, which can represent a two-dimensional (2D) matrix that contains values of parameters used by an original (larger) machine learning model. Using singular value decomposition (SVD) or other processes, the parameter matrix 202 is decomposed into three matrices, which are denoted as a U matrix 204, an S matrix 206, and a V matrix 208. Without any modifications, a product of these three matrices 204-208 should match the original parameter matrix 202 very closely or exactly.

In order to provide model compression, the three matrices 204-208 can be modified so that they have smaller sizes compared to their original sizes (where the original sizes are represented by dashed lines in FIG. 2A). For example, the matrix 206 can represent a singular value matrix having non-zero singular values located only along its diagonal. A specified number of the largest singular values along the diagonal of the matrix 206 can be selected and retained, and the matrix 206 can be truncated to contain only those singular values along its diagonal. The matrix 204 can be truncated so that its number of columns matches the number of singular values contained in the truncated matrix 206. Similarly, the matrix 208 can be truncated so that its number of columns matches the number of singular values contained in the truncated matrix 206. Note that the truncation of the matrix 208 can be done by columns even though it appears to be done by rows in FIG. 2A (due to the matrix 208 being shown in transposed form, as represented by the T superscript in V^{T}). The product of these three truncated matrices 204-208 represents a reconstructed parameter matrix 210, which is not identical to the original parameter matrix 202.

Unfortunately, the approach shown in FIG. 2A can lead to low accuracy, even when only truncating small portions of the parameter values in the matrices 204-208. Here, ranks or factors of the matrices 204-208 associated with smaller singular values in the matrix 206 are truncated first, and the parameters values associated with the truncated ranks or factors will have higher reconstruction errors in the reconstructed parameter matrix 210. The low accuracy that may be achieved here is due to the fact that the SVD approach assumes that small singular values are less important, but this assumption is not always true. Among other things, an optimization objective used in the SVD approach does not consider the phenomenon that different parameters contribute to task accuracy unevenly. In some cases, this can create results as shown in FIG. 2A, where more important parameters 212 from the parameter matrix 202 can overlap significantly with poorly-reconstructed parameters 214 in the reconstructed parameter matrix 210. In other words, some of the more important parameters 212 from the parameter matrix 202 may be poorly-reconstructed in the reconstructed parameter matrix 210 due to the truncations performed on the matrices 204-208. As a result, truncating smaller singular values can cause large drops in performance of a compressed machine learning model that is designed based on the matrices 204-208.

As shown in FIG. 2B, the weighted low-rank factorization 250 is used in conjunction with a parameter matrix (W) 252, which again contains values of parameters used by an original (larger) machine learning model. Using SVD or other processes, the parameter matrix 252 is decomposed into three matrices, which are denoted as a U* matrix 254, an S* matrix 256, and a V* matrix 258. In addition, importance values 253 are used to represent the importances of the singular values contained along the diagonal of the S* matrix 256. The importances of the singular values may be expressed in any suitable manner, such as by using relative importance values or absolute importance values. The importance values can be used as indicators of which of the singular values contained in the S* matrix 256 are more important and which are less important. One example technique for determining the importance values 253 is described below, although any other suitable technique may be used here.

By incorporating the consideration of the importance values 253 into model compression, this approach allows the importance values 253 and the matrices 254-258 to be used to generate a compressed machine learning model that is more accurate compared to the other approach discussed above. The product of the importance values 253 and these three matrices 254-258 represents a reconstructed parameter matrix 260. The reconstructed parameter matrix 260, while still not identical to the original parameter matrix 252, can represent more important parameters 262 of the original parameter matrix 252 in an improved manner. This is because the reconstructed parameter matrix 260 includes far less overlap (and ideally no overlap) between the more important parameters 262 from the parameter matrix 252 and poorly-reconstructed parameters 264 in the reconstructed parameter matrix 260. In other words, the poorly-reconstructed parameters 264 are ideally associated only with less important parameters from the parameter matrix 252. As a result, a compressed machine learning model generated using the importance values 253 and the matrices 254-258 can achieve improved accuracy and performance since the more important parameters 262 from the parameter matrix 252 are represented better, even if those more important parameters 262 happen to be associated with smaller singular values in the matrix 256. Additional details for performing the weighted low-rank factorization 250 are provided below.

Although FIGS. 2A and 2B illustrate examples of low-rank factorizations 200, 250 for compressing machine learning models, various changes may be made to FIGS. 2A and 2B. For example, each of the various matrices may have any suitable size, shape, and dimensions.

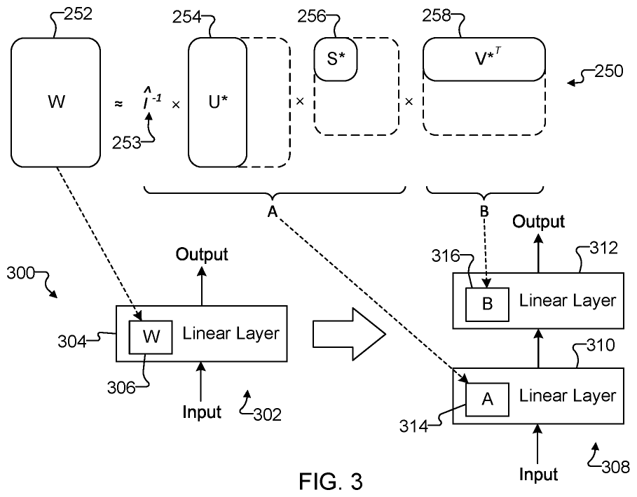

FIG. 3 illustrates an example usage of the weighted low-rank factorization 250 for compressing a machine learning model in accordance with this disclosure. For ease of explanation, the weighted low-rank factorization 250 is described as being used by the electronic device 101, server 106, or other device in the network configuration 100 of FIG. 1. However, a machine learning model may be compressed using any other suitable device(s) and in any other suitable system(s).

As shown in FIG. 3, the parameter matrix 252 here may be associated with an original (larger) machine learning model 302. In this example, the machine learning model 302 includes a linear layer 304, and the parameter matrix 252 can represent or otherwise be associated with a parameter matrix 306 of the linear layer 304. Due to the size of the linear layer 304 specifically and the machine learning model 302 generally, the machine learning model 302 may be unsuitable for use in certain situations. For instance, it may be impractical or impossible to store and use the machine learning model 302 on resource-constrained devices, such as mobile devices or Internet-of-things (IoT) devices.

Using the weighted low-rank factorization 250 described above with respect to FIG. 2B, the machine learning model 302 can be compressed to produce a compressed machine learning model 308. Here, the compressed machine learning model 308 uses two linear layers 310 and 312 to implement the linear layer 304 of the original machine learning model 302. Based on the weighted low-rank factorization 250, the importance values 253, the U* matrix 254 (after truncation), and the S* matrix 256 (after truncation) can be used to produce a parameter matrix A 314 for the first linear layer 310. Also, the V* matrix 258 (after truncation and transposition) can be used to produce a parameter matrix B 316 for the second linear layer 312. Because the matrices 254-258 are smaller than the parameter matrix 306, the resulting parameter matrices 314-316 used in the linear layers 310-312 can be significantly smaller than the parameter matrix 306, which helps in the production of the compressed machine learning model 308. As a result, use of the compressed machine learning model 308 can result in significant reductions in computational complexity, memory usage, and power consumption during inferencing.

In some embodiments, the determination of the parameter matrices 314-316 can be performed as follows. Let I_{W} represent the Fisher information available in the original parameter matrix 306. Also, let [symbol] represent a task loss function, which refers to a loss function used to train the original machine learning model 302. As particular examples, the task loss function may represent a cross-entropy loss for a machine learning model trained to perform a classification task or a mean-squared error for a machine learning model trained to perform a regression task. Further, let w represent parameters of the parameter matrix 306 (such as parameters of the linear layer 304), D represent a validation dataset, and dᵢ represent individual data in the validation dataset D. Based on these notations, an estimate (denoted Î_{W}) of the Fisher information available in the original parameter matrix 306 can be determined as follows.

$${I}_{w} = E [ {( \frac{\partial }{\partial w} log p ( D \vert w ) )}^{2} ] \approx \frac{1}{\vert D \vert} {\sum }_{i = 1}^{\vert D \vert} {( \frac{\partial }{\partial w} ℒ ( {d}_{i} ; w ) )}^{2} = {Î}_{W} \qquad ( 1 )$$

Here, the estimate Î_{W} of the Fisher information available in the original parameter matrix 306 can represent the importance values 253. Based on using Equation (1) to identify the importance values 253, the matrices 314-316 can be determined by solving the following optimization objective problem.

$${min}_{A , B} {\sum }_{i , j} {\hat{I}}_{{W}_{ij}} {( {W}_{ij} - {( A B )}_{ij} )}^{2} \qquad ( 2 )$$

Here, ij represents matrix entries (such as a value at the i^{th} row and j^{th} column of a matrix), Wᵢⱼ represents a specific element in the parameter matrix W 306, and Î_{W}_{ᵢⱼ} represents a scalar value that defines the importance of the corresponding Wᵢⱼ element in the parameter matrix W 306. Also, A represents the parameter matrix 314, B represents the parameter matrix 316, and (AB)ᵢⱼ represents the (i, j)^{th} entry in the product of the A and B matrices. The expression (Wᵢⱼ−(AB)ᵢⱼ) represents an error between (i) a specific parameter value in the parameter matrix W 306 and (ii) an approximated parameter value for the same specific parameter value (where the approximated parameter value is generated using the A and B matrices). This error is weighted using Î_{W}_{ᵢⱼ}, which represents the importance value 253 associated with this specific parameter value in the parameter matrix W 306. As a result, the parameter matrices 314 and 316 (and therefore the matrices 254-258) are generated based on weighted errors between the parameter values in the parameter matrix W 306 and the approximated parameter values, where weights associated with the weighted errors are based on the importance values 253.

There are various ways in which the optimization objective problem of Equation (2) can be solved. For example, in a first approach for solving the optimization objective problem of Equation (2), the importance values 253 can be estimated using Equation (1), which is rewritten below for convenience.

$${Î}_{W} = \frac{1}{\vert D \vert} {\sum }_{i = 1}^{\vert D \vert} {( \frac{\partial }{\partial w} ℒ ( {d}_{i} ; w ) )}^{2} \qquad ( 3 )$$

The importance values 253 in this example are determined using the validation dataset D. The importance values 253 are in the form of a matrix, and the importance values 253 in each row can be aggregated or otherwise combined. In some cases, this combination can be expressed as follows.

Î_{W}_{ᵢ}=ΣⱼÎ_{W}_{ᵢⱼ} (4)

Î=diag(\sqrt{Î_{W}_{₁}}, . . . ,{square root over (Î_{W}_{_{N}})}) (5)

This results in a diagonal matrix Î, where each diagonal entry of the diagonal matrix Î represents the combination of the original importance values 253 in the associated row. The aggregated importance values along the diagonals of the diagonal matrix Î may be referred to as row-wise importance values. As a particular example of this, the following represents one example of original importance values 253 (Î_{W}) that may be determined using Equation (1) and one example of a resulting diagonal matrix (Î) that may be determined using Equations (4) and (5).

$${\hat{I}}_{W} = [ \begin{matrix}0.3 & 0.8 & 0.6 \\ 0.2 & 0.1 & 0.2 \\ 2.2 & 5.3 & 6.1\end{matrix} ] , \hat{I} = [ \begin{matrix}1.3 & 0 & 0 \\ 0 & 0.7 & 0 \\ 0 & 0 & 3.6\end{matrix} ] \qquad ( 6 )$$

Using only row-wise importance values, the optimization objective problem of Equation (2) can be simplified, such as into the following form.

$${min}_{A , B} {\sum }_{i , j} {{\hat{I}}_{{W}_{ij}} ( {W}_{ij} - {( A B )}_{ij} )}^{2} = {min}_{A , B} {‖ {\hat{I}}_{W} - {\hat{I}}_{AB} ‖}_{2} \qquad ( 7 )$$

The optimization objective problem of Equation (7) can be solved, such as by using a standard SVD solver or other solver, which leads to the generation of the matrices 254-258 having their original sizes.

At this point, the matrices 254-258 can be processed in order to reduce their sizes. For example, a rank r to be preserved can be determined, such as based on at least one end user device to use a compressed machine learning model being generated. In some cases, the selection of the rank r can be based on one or more hardware limitations of the end user device(s). Thus, for instance, if an end user device has larger memory, the preserved rank r can be larger. Otherwise, the preserved rank r can be reduced until a compressed machine learning model can fit into the end user device's memory. Once the rank r is selected, the matrix 256 can be truncated by selecting the r largest singular values on the diagonal of the matrix 256 and truncating all rows and columns containing other singular values on the diagonal of the matrix 256. Also, the matrices 254 and 258 can be truncated to preserve r columns in each matrix 254 and 258. In some embodiments, the matrix 256 can have k×k dimensions prior to truncation and r×r dimensions after truncation, and each matrix 254 and 258 can have p×k dimensions prior to truncation and p×r dimensions after truncation (where p is the dimension of an input vector). From these matrices 254-258, the parameter matrices 314 and 316 can be determined as follows.

A=Î⁻¹U*S* (8)

B=V*^{T} (9)

The A and B matrices can be used as the parameter matrices 314 and 316 for the linear layers 310 and 312. Note that this process can be repeated for each linear layer contained in at least one machine learning model in order to produce one or more final compressed machine learning models. Once completed, fine-tuning of the compressed machine learning model(s) may occur, such as by using the same training data that was previously used to train the original larger machine learning model(s).

In a second approach for solving the optimization objective problem of Equation (2), the full optimization objective problem of Equation (2) (rather than the simplified optimization objective problem of Equation (7)) can be solved using an optimizer, such as a standard stochastic gradient descent (SGD) optimizer, an Alternating Least Squares (ALS) optimizer, an Adaptive Moment Estimation (Adam) optimizer, or a hybrid optimizer of SGD and Adam. A possible hybrid optimizer of SGD and Adam can be an optimizer that first conducts adaptive moment estimation optimization and then, at some switching point, switches to conducting stochastic gradient descent optimization. In some cases, the loss provided by the solution of Equation (7) can be used as the switching point from adaptive moment estimation to SGD, and the switching point here can be called a switching threshold. The training process will be optimized by adaptive moment estimation optimization when the current loss is larger than this threshold and taken over by stochastic gradient descent optimization when its loss is smaller than the threshold. The optimizer can use the updated A and B matrices to solve the optimization objective problem of Equation (2) until the objective function converges. This results in the production of finalized A and B matrices, which can be used as the parameter matrices 314 and 316 for the linear layers 310 and 312. Again, this process can be repeated for each linear layer contained in at least one machine learning model in order to produce one or more final compressed machine learning models. Once completed, fine-tuning of the compressed machine learning model(s) may occur, such as by using the same training data that was previously used to train the original larger machine learning model(s). Note that, in other embodiments, a single optimizer may be used to solve for the A and B matrices.

Although FIG. 3 illustrates one example of a usage of weighted low-rank factorization 250 for compressing a machine learning model, various changes may be made to FIG. 3. For example, each of the various matrices may have any suitable size, shape, and dimensions. Also, a machine learning model may include any suitable number of layers that are compressed using weighted low-rank factorization 250.

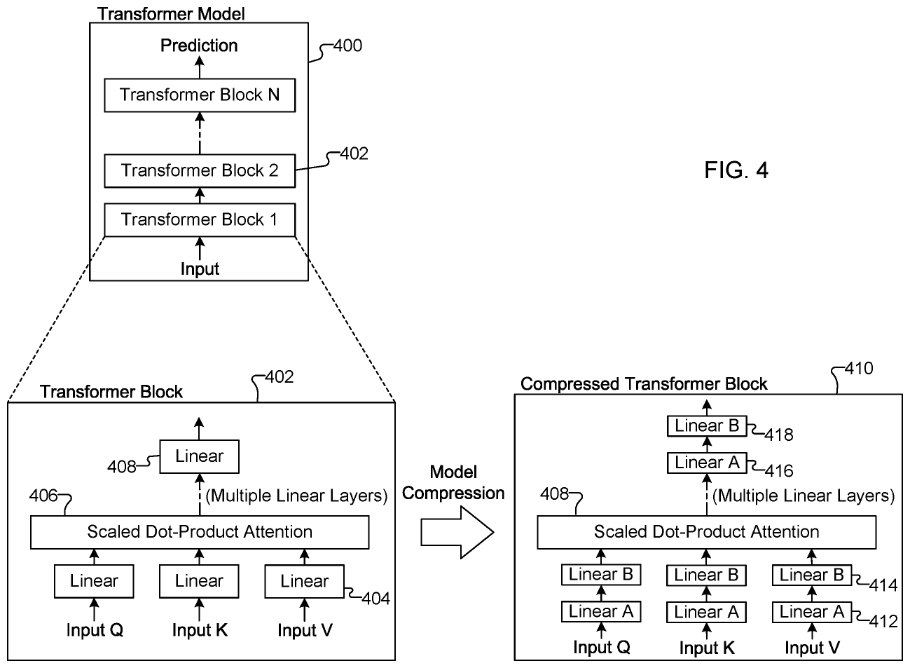

FIG. 4 illustrates an example generation of a compressed machine learning model using weighted low-rank factorization 250 in accordance with this disclosure. For ease of explanation, the generation of the compressed machine learning model in FIG. 4 is described as being performed by the electronic device 101, server 106, or other device in the network configuration 100 of FIG. 1 using the weighted low-rank factorization 250 of FIG. 2B and the approach shown in FIG. 3. However, a machine learning model may be compressed using any other suitable device(s) in any other suitable manner and in any other suitable system(s).

As shown in FIG. 4, an original machine learning model 400 represents a transformer model, which is a common structure used in machine learning systems. The original machine learning model 400 includes a number of transformer blocks 402, each of which is configured to receive input data and generate output data. The final transformer block 402 in the machine learning model 400 can output predictions based on the input data being processed. Each transformer block 402 here can include one or more initial linear layers 404, each of which can receive and process input data. A scaled dot-product attention block 406 can be used to provide more attention (larger weight) or less attention (smaller weight) to various outputs from the initial linear layers 404. A final linear layer 408 can process the outputs of the scaled dot-product attention block 406 (or a previous linear layer) in order to produce final outputs of the transformer block 402. Note that one or more additional linear layers or other layers may be positioned between the scaled dot-product attention block 406 and the final linear layer 408 if needed or desired.

By applying the weighted low-rank factorization 250 to each linear layer 404 and 408 of each transformer block 402, a corresponding compressed transformer block 410 can be produced for each transformer block 402. Here, each compressed transformer block 410 can include the scaled dot-product attention block 406 from the corresponding transformer block 402. However, each linear layer 404 of the corresponding transformer block 402 has been replaced with two linear layers 412-414 in the compressed transformer block 410, and the linear layer 408 of the corresponding transformer block 402 has been replaced with two linear layers 416-418 in the compressed transformer block 410. While not shown here, any other linear layers of a transformer block 402 may similarly be replaced by multiple linear layers in its compressed transformer block 410. The end result here is a compressed transformer model with compressed transformer blocks 410 that are smaller (and possibly significantly smaller) than the transformer blocks 402. Moreover, the compressed transformer model can be as accurate as (or substantially as accurate as) the original transformer model since the weighted low-rank factorization 250 helps to ensure that more important parameters of the original machine learning model 400 can be reconstructed more accurately in the compressed machine learning model.

Although FIG. 4 illustrates one example of the generation of a compressed machine learning model using weighted low-rank factorization 250, various changes may be made to FIG. 4. For example, the specific machine learning model 400 being compressed here is for illustration only. Other machine learning models having other forms and structures with any suitable number(s) of layer(s) may be compressed in the same or similar manner as described above.

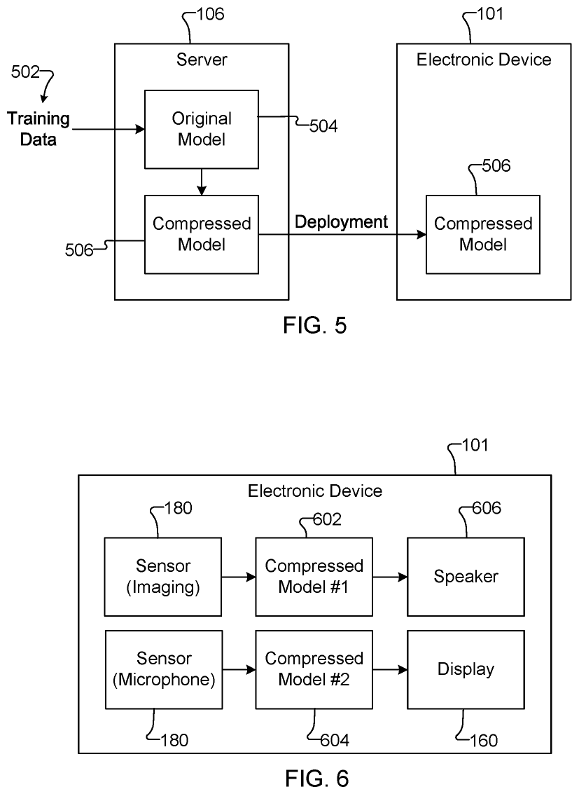

FIG. 5 illustrates an example generation and deployment of a compressed machine learning model in accordance with this disclosure. For ease of explanation, the generation and deployment of the compressed machine learning model is described as involving the electronic device 101 and the server 106 in the network configuration 100 of FIG. 1. However, the generation and deployment of a compressed machine learning model may involve the use of any other suitable device(s) and in any other suitable system(s).

As shown in FIG. 5, the server 106 uses training data 502 to produce an original machine learning model 504. The training data 502 may be obtained from any suitable source(s) (such as one or more public or private repositories), generated by the server 106, or otherwise obtained in any suitable manner. The original machine learning model 504 can represent any suitable machine learning model to be compressed, and the original machine learning model 504 can be generated in any suitable manner. The server 106 uses weighted low-rank factorization 250 to compress the original machine learning model 504 and produce a compressed machine learning model 506. If desired, the compressed machine learning model 506 can be fine-tuned, such as by retraining the compressed machine learning model 506 using the same training data 502 used to train the original machine learning model 504. Once generation and optional tuning of the compressed machine learning model 506 are complete, the compressed machine learning model 506 can be deployed, such as to one or more end user devices (like the electronic device 101).

As noted above, the rank r used in the generation of the compressed machine learning model 506 during the weighted low-rank factorization 250 can be based at least partially on the hardware limitation of the electronic device 101 to receive and use the compressed machine learning model 506. Thus, for example, the matrices 254-258 can have a larger rank r if the electronic device 101 has larger memory and greater processing resources. In contrast, the matrices 254-258 can have a smaller rank r if the electronic device 101 has smaller memory and fewer processing resources.

Although FIG. 5 illustrates one example of the generation and deployment of a compressed machine learning model, various changes may be made to FIG. 5. For example, the original machine learning model 504 could be obtained (rather than generated) and used to produce the compressed machine learning model 506. Also, the compressed machine learning model 506 may be used on the same device that generated the compressed machine learning model 506, or the compressed machine learning model 506 may be provided to any suitable number of end user devices.

FIG. 6 illustrates an example usage of a compressed machine learning model in accordance with this disclosure. For ease of explanation, the usage of the compressed machine learning model is described as involving the electronic device 101 in the network configuration 100 of FIG. 1. However, a compressed machine learning model may be used by any other suitable device(s) and in any other suitable system(s).

As shown in FIG. 6, the electronic device 101 here includes or has access to multiple compressed machine learning models 602-604. Each compressed machine learning model 602-604 may be associated with an original machine learning model that was compressed using weighted low-rank factorization 250 as described above. One compressed machine learning model 602 in this example can be used to process one type of input data, such as image data from at least one camera (one or more sensors 180). Another compressed machine learning model 604 in this example can be used to process another type of input data, such as audio data from at least one microphone (one or more other sensors 180). The compressed machine learning model 602 can process the image data here and generate audio data to be presented to a user via a speaker 606 of the electronic device 101. The compressed machine learning model 604 can process the audio data here and initiate one or more actions involving the audio data, which may include presenting information on the display 160.

As a particular example, the compressed machine learning model 602 may be trained to perform image classification, where the compressed machine learning model 602 receives images and identifies the likely contents of the images. Thus, for example, the compressed machine learning model 602 may receive an image of a road with a crosswalk from a camera and output the phrase “road crossing” to the user via the speaker 606. As another particular example, the compressed machine learning model 604 may be trained to perform automatic speech recognition (ASR) or natural language understanding (NLU) in order to provide a virtual assistant function. Thus, for instance, the compressed machine learning model 604 may receive audio data of “Hey BIXBY, call mom” and cause the electronic device 101 to (i) display “Calling Mom” on the display 160 and (ii) initiate a telephone call or other communication session with a “mom” contact stored on the electronic device 101.

Note that these are examples only and do not limit the scope of this disclosure. In general, one or more compressed machine learning models may be used to process any suitable input data and generate any suitable predictions or perform any suitable actions in response to the input data. As particular examples, one or more machine learning models may be used to process text data, audio data, image data, or other data. Also, as particular examples, the one or more machine learning models may be used to generate speech-to-text predictions (which represent text corresponding to spoken speech by users), text sentiments (which represent the sentiments or attitudes of incoming or outgoing text messages, email messages, etc.), image classifications (which represent classifications of contents within images), or other outputs. In addition, as particular examples, the one or more machine learning models may be used to initiate display of text (such as one or more predictions) to a user via the display 160, open or invoke a function of an “app” on the electronic device 101, or perform other actions.

Although FIG. 6 illustrates one example of a usage of a compressed machine learning model, various changes may be made to FIG. 6. For example, an electronic device 101 or other device may include any suitable number of compressed machine learning models, and each compressed machine learning model may be used to process any suitable input data and produce any suitable results.

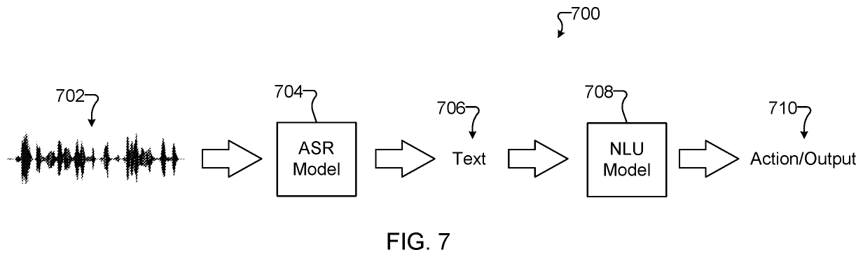

FIG. 7 illustrates an example use case 700 for multiple compressed machine learning models in accordance with this disclosure. For ease of explanation, the use case 700 for the compressed machine learning models is described as involving the electronic device 101 in the network configuration 100 of FIG. 1. However, one or more compressed machine learning models may be used by any other suitable device(s) and in any other suitable system(s).

As shown in FIG. 7, audio input data 702 is received and processed using an ASR model 704, which can represent a first compressed machine learning model. The ASR model 704 converts the audio input data 702 into text 706. The text 706 is received and processed using an NLU model 708, which can represent a second compressed machine learning model. The NLU model 708 can process the text 706 in order to determine whether to initiate one or more actions or generate one or more outputs 710. Because the models 704 and 708 can represent compressed models generated using weighted low-rank factorization 250, the models 704 and 708 can be substantially as accurate as original ASR/NLU models but can be substantially smaller than the original ASR/NLU models.

As a particular example of this functionality, the audio input data 702 may include an utterance of “BIXBY, navigate to the nearest grocery store” captured from a user. The ASR model 704 can convert the audio input data 702 into text 706 that says “BIXBY, navigate to the nearest grocery store.” The NLU model 708 can process this text 706 and initiate an action that causes a map app on an electronic device to open and display navigation instructions from the user's current location to the nearest grocery store.

Although FIG. 7 illustrates one example of a use case for multiple compressed machine learning models, various changes may be made to FIG. 7. For example, an electronic device 101 or other device may include any suitable number of compressed machine learning models that are used for any suitable purpose(s).

It should be noted that the functions shown in or described with respect to FIGS. 2 through 7 can be implemented in an electronic device 101, server 106, or other device(s) in any suitable manner. For example, in some embodiments, at least some of the functions shown in or described with respect to FIGS. 2 through 7 can be implemented or supported using one or more software applications or other software instructions that are executed by the processor(s) 120 of the electronic device 101, server 106, and/or other device. In other embodiments, at least some of the functions shown in or described with respect to FIGS. 2 through 7 can be implemented or supported using dedicated hardware components. In general, the functions shown in or described with respect to FIGS. 2 through 7 can be performed using any suitable hardware or any suitable combination of hardware and software/firmware instructions. Also, the functions shown in or described with respect to FIGS. 2 through 7 can be performed by a single device or by multiple devices.

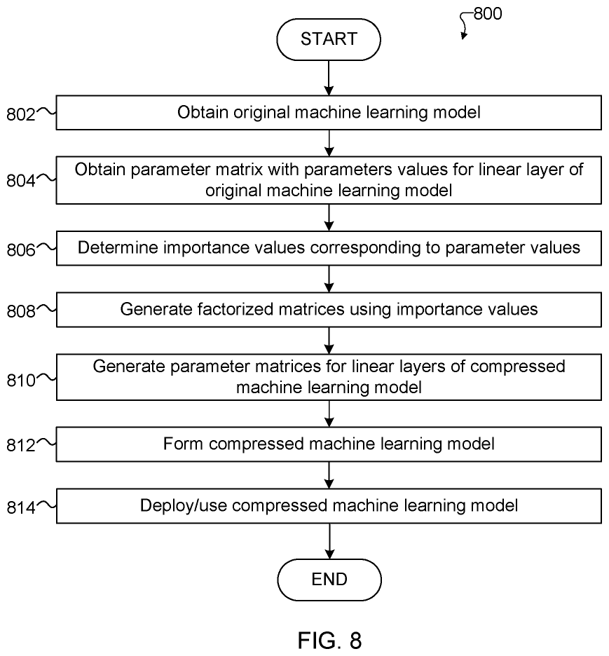

FIG. 8 illustrates an example method 800 for generating and deploying a compressed machine learning model in accordance with this disclosure. For ease of explanation, the method 800 is described as being performed by the server 106 in the network configuration 100 of FIG. 1. However, the method 800 may be performed by any other suitable device(s) and in any other suitable system(s).

As shown in FIG. 8, an original machine learning model is obtained at step 802, and a parameter matrix containing parameter values for a linear layer of the original machine learning model is obtained at step 804. This may include, for example, the processor 120 of the server 106 generating or otherwise obtaining an original machine learning model 400, 504 that has been trained to perform at least one task. This may also include the processor 120 of the server 106 identifying the parameter matrix 306 of a linear layer 304, 404, 408 in the original machine learning model.

Importance values corresponding to the parameter values are determined at step 806. This may include, for example, the processor 120 of the server 106 using the approach shown in Equation (1) above to identify the importance values 253 corresponding to the parameters associated with the parameter matrix 306 of the original machine learning model. Factorized matrices are generated for the linear layer using the importance values associated with the parameters of the linear layer at step 808, and parameter matrices are generated for multiple linear layers of a compressed machine learning model at step 810. In some cases, this may include, for example, the processor 120 of the server 106 using the first approach described above in which importance values 253 in rows are combined as in Equations (4) and (5), a simplified optimization objective problem as in Equation (7) is solved, and the resulting matrices 254-258 are truncated based on a selected rank r to produce A and B parameter matrices 314-316. In other cases, this may include the processor 120 of the server 106 using the second approach described above in which an optimizer is used with Equation (2) to identify finalized A and B parameter matrices 314-316.

A compressed machine learning model is formed at step 812 and deployed or used at step 814. This may include, for example, the processor 120 of the server 106 packaging the A and B parameter matrices 314-316 for the linear layer of the compressed machine learning model 506, 602, 604, 704, 708 with other layers and components of the compressed machine learning model. This may also include the processor 120 of the server 106 sending the packaged contents to one or more other devices for use, such as by one or more end user devices (like the electronic device 101), or using the compressed machine learning model at the server 106.

Although FIG. 8 illustrates one example of a method 800 for generating and deploying a compressed machine learning model, various changes may be made to FIG. 8. For example, while shown as a series of steps, various steps in FIG. 8 may overlap, occur in parallel, occur in a different order, or occur any number of times. As a particular example, steps in FIG. 8 may be repeated to produce A and B parameter matrices 314-316 for each linear layer 304, 404, 408 of the original machine learning model, and those parameter matrices 314-316 can be included in the compressed machine learning model. As another particular example, steps in FIG. 8 may be repeated in order to compress multiple machine learning models.

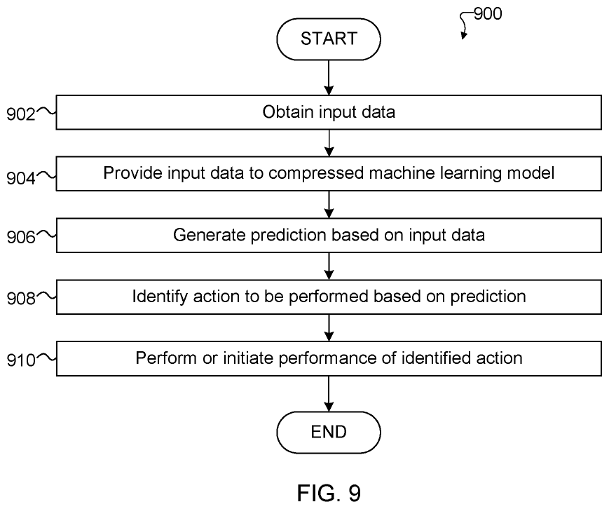

FIG. 9 illustrates an example method 900 for using a compressed machine learning model in accordance with this disclosure. For ease of explanation, the method 900 is described as being performed by the electronic device 101 in the network configuration 100 of FIG. 1. However, the method 900 may be performed by any other suitable device(s) and in any other suitable system(s).

As shown in FIG. 9, input data is obtained at step 902. This may include, for example, the processor 120 of the electronic device 101 obtaining one or more of text data, audio data, and image data from any suitable source(s), such as one or more other components of the electronic device 101. The input data is provided to at least one compressed machine learning model at step 904. This may include, for example, the processor 120 of the electronic device 101 providing the input data to one or more compressed machine learning models 506, 602, 604, 704, 708. At least one prediction is generated using the compressed machine learning model(s) at step 906. This may include, for example, the processor 120 of the electronic device 101 using the one or more compressed machine learning models to generate one or more predictions associated with the input data. Any suitable predictions may be generated here, such as one or more of speech-to-text predictions, text sentiments, or image classifications.

One or more actions to be performed are identified based on the prediction(s) at step 908, and the one or more actions are performed or initiated at step 910. This may include, for example, the processor 120 of the electronic device 101 determining one or more actions based on the identified prediction(s) in order to satisfy a user intent. Any suitable action or actions may occur here, such as one or more of displaying a prediction or information associated with a prediction to a user, opening an app on the electronic device 101, or invoking a function of an app on the electronic device 101.

Although FIG. 9 illustrates one example of a method 900 for using a compressed machine learning model, various changes may be made to FIG. 9. For example, while shown as a series of steps, various steps in FIG. 9 may overlap, occur in parallel, occur in a different order, or occur any number of times. Also, the examples of input data, predictions, and actions provided above are merely examples, and one or more compressed machine learning models may be used in any other suitable manner.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, a parameter matrix associated with a linear layer of a first machine learning model and containing parameter values for parameters of the linear layer of the first machine learning model;
determining, using the at least one processing device, importance values corresponding to the parameter values;
generating, using the at least one processing device, factorized matrices such that a product of the importance values and the factorized matrices contains approximated parameter values for the parameters of the linear layer of the first machine learning model; and
generating, using the at least one processing device, a second machine learning model representing a compressed version of the first machine learning model, the second machine learning model having first and second linear layers containing parameter values based on the importance values and the factorized matrices;
wherein the factorized matrices are generated based on weighted errors between the parameter values for the parameters of the linear layer of the first machine learning model and the approximated parameter values, and wherein weights associated with the weighted errors are based on the importance values.

2. The method of claim 1, wherein generating the factorized matrices comprises using an objective function of:
$${min}_{A , B} {\sum }_{i , j} {{\hat{I}}_{{W}_{ij}} ( {W}_{ij} - {( A B )}_{ij} )}^{2}$$
where:
W represents the parameter matrix containing the parameter values;
A and B represent parameter matrices based on the importance values and the factorized matrices;
i and j are matrix indices; and
Î_{W}_{ᵢⱼ} represents the importance value associated with the parameter value in position (i,j) within the parameter matrix.

3. The method of claim 2, wherein generating the factorized matrices further comprises:
determining an initial importance value of each parameter of the linear layer of the first machine learning model using a validation dataset to generate an initial importance parameter matrix;
aggregating the initial importance values in each row of the initial importance parameter matrix to generate a diagonal importance parameter matrix containing aggregated importance values; and
using the aggregated importance values contained in the diagonal importance parameter matrix as the importance values Î_{W}_{ᵢⱼ} in the objective function to generate the factorized matrices.

4. The method of claim 3, wherein:
the factorized matrices include first, second, and third matrices;
generating the factorized matrices further comprises:
selecting a rank r to be preserved based on an end user device to use the second machine learning model;
truncating the first matrix to preserve r largest singular values along its diagonal; and
truncating each of the second and third matrices to preserve r columns;
the first and second matrices are used to generate the parameter values of the first linear layer of the second machine learning model; and
the third matrix is used to generate the parameter values of the second linear layer of the second machine learning model.

5. The method of claim 2, wherein generating the factorized matrices further comprises:
using adaptive moment estimation optimization to generate first factorized matrices based on the objective function; and
using stochastic gradient descent optimization to generate second factorized matrices based on the first factorized matrices and the objective function, the second factorized matrices used to generate the second machine learning model.

6. The method of claim 1, wherein:
the first machine learning model comprises multiple linear layers; and
the second machine learning model comprises multiple pairs of linear layers, each pair of linear layers of the second machine learning model corresponding to one of the linear layers of the first machine learning model and generated using an associated set of factorized matrices.

7. The method of claim 1, further comprising:
obtaining an additional parameter matrix associated with a linear layer of a third machine learning model and containing additional parameter values for parameters of the linear layer of the third machine learning model;
determining additional importance values corresponding to the additional parameter values;
generating additional factorized matrices such that a product of the additional factorized matrices contains additional approximated parameter values for the parameters of the linear layer of the third machine learning model; and
generating a fourth machine learning model representing a compressed version of the third machine learning model, the fourth machine learning model having multiple linear layers containing parameter values based on the additional factorized matrices.

8. An apparatus comprising:
at least one processing device configured to:
obtain a parameter matrix associated with a linear layer of a first machine learning model and containing parameter values for parameters of the linear layer of the first machine learning model;
determine importance values corresponding to the parameter values;
generate factorized matrices such that a product of the importance values and the factorized matrices contains approximated parameter values for the parameters of the linear layer of the first machine learning model; and
generate a second machine learning model representing a compressed version of the first machine learning model, the second machine learning model having first and second linear layers containing parameter values based on the importance values and the factorized matrices;
wherein the at least one processing device is configured to generate the factorized matrices based on weighted errors between the parameter values for the parameters of the linear layer of the first machine learning model and the approximated parameter values, and wherein weights associated with the weighted errors are based on the importance values.

9. The apparatus of claim 8, wherein, to generate the factorized matrices, the at least one processing device is further configured to use an objective function of:
$${min}_{A , B} {\sum }_{i , j} {{\hat{I}}_{{W}_{ij}} ( {W}_{ij} - {( A B )}_{ij} )}^{2}$$
where:
W represents the parameter matrix containing the parameter values;
A and B represent parameter matrices based on the importance values and the factorized matrices;
i and j are matrix indices; and
Î_{W}_{ᵢⱼ} represents the importance value associated with the parameter value in position (i,j) within the parameter matrix.

10. The apparatus of claim 9, wherein, to generate the factorized matrices, the at least one processing device is further configured to:
determine an initial importance value of each parameter of the linear layer of the first machine learning model using a validation dataset to generate an initial importance parameter matrix;
aggregate the initial importance values in each row of the initial importance parameter matrix to generate a diagonal importance parameter matrix containing aggregated importance values; and
use the aggregated importance values contained in the diagonal importance parameter matrix as the importance values Î_{W}_{ᵢⱼ} in the objective function to generate the factorized matrices.

11. The apparatus of claim 10, wherein:
the factorized matrices include first, second, and third matrices;
to generate the factorized matrices, the at least one processing device is further configured to:
select a rank r to be preserved based on an end user device to use the second machine learning model;
truncate the first matrix to preserve r largest singular values along its diagonal; and
truncate each of the second and third matrices to preserve r columns;
the at least one processing device is configured to use the first and second matrices to generate the parameter values of the first linear layer of the second machine learning model; and
the at least one processing device is configured to use the third matrix to generate the parameter values of the second linear layer of the second machine learning model.

12. The apparatus of claim 9, wherein, to generate the factorized matrices, the at least one processing device is further configured to:
use adaptive moment estimation optimization to generate first factorized matrices based on the objective function; and
use stochastic gradient descent optimization to generate second factorized matrices based on the first factorized matrices and the objective function, the second factorized matrices used to generate the second machine learning model.

13. The apparatus of claim 8, wherein:
the first machine learning model comprises multiple linear layers; and
the second machine learning model comprises multiple pairs of linear layers, each pair of linear layers of the second machine learning model corresponding to one of the linear layers of the first machine learning model and generated using an associated set of factorized matrices.

14. The apparatus of claim 8, wherein the at least one processing device is further configured to:
obtain an additional parameter matrix associated with a linear layer of a third machine learning model and containing additional parameter values for parameters of the linear layer of the third machine learning model;
determine additional importance values corresponding to the additional parameter values;
generate additional factorized matrices such that a product of the additional factorized matrices contains additional approximated parameter values for the parameters of the linear layer of the third machine learning model; and
generate a fourth machine learning model representing a compressed version of the third machine learning model, the fourth machine learning model having multiple linear layers containing parameter values based on the additional factorized matrices.

15. A non-transitory computer readable medium containing instructions that when executed cause at least one processor to:
obtain a parameter matrix associated with a linear layer of a first machine learning model and containing parameter values for parameters of the linear layer of the first machine learning model;
determine importance values corresponding to the parameter values;
generate factorized matrices such that a product of the importance values and the factorized matrices contains approximated parameter values for the parameters of the linear layer of the first machine learning model; and
generate a second machine learning model representing a compressed version of the first machine learning model, the second machine learning model having first and second linear layers containing parameter values based on the importance values and the factorized matrices;
wherein the instructions that when executed cause the at least one processor to generate the factorized matrices comprise instructions that when executed cause the at least one processor to generate the factorized matrices based on weighted errors between the parameter values for the parameters of the linear layer of the first machine learning model and the approximated parameter values, and wherein weights associated with the weighted errors are based on the importance values.

16. The non-transitory computer readable medium of claim 15, wherein the instructions that when executed cause the at least one processor to generate the factorized matrices further comprise instructions that when executed cause the at least one processor to use an objective function of:
$${min}_{A , B} {\sum }_{i , j} {{\hat{I}}_{{W}_{ij}} ( {W}_{ij} - {( A B )}_{ij} )}^{2}$$
where:
W represents the parameter matrix containing the parameter values;
A and B represent parameter matrices based on the importance values and the factorized matrices;
i and j are matrix indices; and
Î_{W}_{ᵢⱼ} represents the importance value associated with the parameter value in position (i,j) within the parameter matrix.

17. The non-transitory computer readable medium of claim 16, wherein the instructions that when executed cause the at least one processor to generate the factorized matrices further comprise instructions that when executed cause the at least one processor to:
determine an initial importance value of each parameter of the linear layer of the first machine learning model using a validation dataset to generate an initial importance parameter matrix;
aggregate the initial importance values in each row of the initial importance parameter matrix to generate a diagonal importance parameter matrix containing aggregated importance values; and
use the aggregated importance values contained in the diagonal importance parameter matrix as the importance values Î_{W}_{ᵢⱼ} in the objective function to generate the factorized matrices.

18. The non-transitory computer readable medium of claim 17, wherein:
the factorized matrices include first, second, and third matrices;
the instructions that when executed cause the at least one processor to generate the factorized matrices further comprise instructions that when executed cause the at least one processor to:
select a rank r to be preserved based on an end user device to use the second machine learning model;
truncate the first matrix to preserve r largest singular values along its diagonal; and
truncate each of the second and third matrices to preserve r columns;
the instructions when executed cause the at least one processor to use the first and second matrices to generate the parameter values of the first linear layer of the second machine learning model; and
the instructions executed cause the at least one processor to use the third matrix to generate the parameter values of the second linear layer of the second machine learning model.

19. The non-transitory computer readable medium of claim 16, wherein the instructions that when executed cause the at least one processor to generate the factorized matrices further comprise instructions that when executed cause the at least one processor to:
use adaptive moment estimation optimization to generate first factorized matrices based on the objective function; and
use stochastic gradient descent optimization to generate second factorized matrices based on the first factorized matrices and the objective function, the second factorized matrices used to generate the second machine learning model.

20. The non-transitory computer readable medium of claim 15, wherein:
the first machine learning model comprises multiple linear layers; and
the second machine learning model comprises multiple pairs of linear layers, each pair of linear layers of the second machine learning model corresponding to one of the linear layers of the first machine learning model and generated using an associated set of factorized matrices.

21. A method comprising:
obtaining, using at least one processing device of an electronic device, input data;
providing, using the at least one processing device, the input data to a compressed machine learning model in order to generate a prediction; and
performing, using the at least one processing device, an action based on the prediction;
wherein the compressed machine learning model comprises first and second linear layers; and
wherein parameter values of the first and second linear layers are based on factorized matrices corresponding to a parameter matrix containing parameter values of a linear layer of a larger machine learning model, the factorized matrices based on importance values corresponding to the parameter values of the linear layer of the larger machine learning model.

22. The method of claim 21, wherein the input data comprises at least one of: text data, audio data, and image data.

23. The method of claim 21, wherein the prediction comprises at least one of: a speech-to-text prediction, a text sentiment, and an image classification.

24. The method of claim 21, wherein the action comprises at least one of: displaying the prediction to a user, opening an app on the electronic device, and invoking a function of the app on the electronic device.

25. The method of claim 21, wherein the compressed machine learning model is generated by:
obtaining the parameter matrix associated with the linear layer of the larger machine learning model and containing the parameter values for parameters of the linear layer of the larger machine learning model;
determining the importance values;
generating the factorized matrices such that a product of the importance values and the factorized matrices contains approximated parameter values for the parameters of the linear layer of the larger machine learning model; and
generating the compressed machine learning model having the first and second linear layers, the parameter values of the first and second linear layers based on the factorized matrices;
wherein the factorized matrices are based on weighted errors between the parameter values for the parameters of the linear layer of the larger machine learning model and the approximated parameter values, and wherein weights associated with the weighted errors are based on the importance values.

26. The method of claim 21, wherein the factorized matrices are based on a rank to be preserved, the rank based on one or more characteristics of the electronic device.

27. The method of claim 21, wherein the compressed machine learning model is used by the electronic device to process the input data from at least one camera or at least one microphone of the electronic device.
